(19) United States
(12) Patent Application Publication
(10) Pub. No.: US 2008/0104876 A1
(43) Pub. Date: May 8, 2008

(54) Fishing lure

(76) Inventor: Koichi Ito, Shizuoka (JP)

Correspondence Address: Armstrong, Kratz, Quintos,;Hanson & Brooks, LLP, Suite 1000, 1725 K Street, N.W., Washington, DC, 20006, US

(21) Appl. No.: 11/819,059

(22) Filed: Jun. 25, 2007

(30) Foreign Application Priority Data
Nov. 7, 2006 (JP) 2006-301839

(51) Int. Cl. A01K 85/18; A01K 85/00

(52) U.S. Cl. 43/42.06; 43/42.47; 43/42.15

(57) ABSTRACT

A fishing lure includes a lure body which is formed in an appearance imitating a small fish. A lower jaw which is vertically pivotable is provided on the front end of the lure body, and the pivot angle of the lower jaw is adjustable. The lower jaw is pivotally supported by the lure body at the base, and has an angle adjusting mechanism to control the pivot angle of the lower jaw around the pivot.

### CROSS-REFERENCE TO RELATED APPLICATIONS

This application is based upon and claims the benefit of priority from the prior Japanese Patent Application No. 2006-301839, filed on Nov. 7, 2006, the entire contents of which are incorporated herein by reference.

### BACKGROUND OF THE INVENTION

1. Field of the Invention

The present invention relates to a fishing lure.

2. Description of the Related Art

In lure fishing, lures of various shapes, sizes, and devices according to the type or the like of a target fish have been devised. For instance, when a big fish, the so-called fish eater, which mainly eats a small fish as diet is the target fish, a lure having the shape imitating that of a small fish is used. Devices on shapes or colors of the lure have been made to attract target fishes, in other words, in order to obtain the effect of being strongly appealing to the target fishes so as to be more attractive to them.

As a floating lure, for instance, lures called “pencil bait”, “popper”, “splasher” and so on according to its shape have been known. The pencil bait has a shape without a so-called cup at the mouth portion so as to make the lure shake its head right and left (lure action) by rod work, in other words, in response to manipulation of the rod. Note that if it has a cup at the mouth portion, the cup receives water and the lure cannot move in a fashion as if slipping in the vicinity of the water surface.

The popper is a type of lure having the so-called cup, and by pulling the lure linearly by rod work it holds water and makes bubbles or noises (Patent Document 1).

The splasher has a lure body larger than that of the popper type and can splash water with its cup or forehead. It is possible to make a louder noise with this splasher type.

A lure having a lip provided with an eyelet to lock a fishing line, which is rotatably attached to the lure in a pitch direction is disclosed.

(Patent Document 1)

Japanese Patent Application Laid-open No. 2003-125675

Although the above-described lures have excellent functions or actions respectively, these functions or actions are peculiar to the respective types. Especially, the fundamental lure action is determined for each type, which limits the available usage range of the lure.

### SUMMARY OF THE INVENTION

Upon these circumstances, the present invention aims to provide a fishing lure realizing various lure actions, and capable of effectively corresponding to change in fishing circumstance or the like.

A lure of the present invention having a lure body formed in a shape imitating a small fish includes a lower jaw which is vertically attached rotatavely on the front end of the above-described lure body, in which the pivot angle of the lower jaw is adjustable.

In the fishing lure of the present invention, the above-described lower jaw is pivotally supported by the above-described lure body at the base, and an angle adjusting mechanism controlling the pivot angle of the above-described lower jaw is included around the pivot.

In the fishing lure of the present invention, the above-described adjusting mechanism includes a gear integrally formed on the above-described lower jaw around the above-described pivot, and a locking piece held by the above-described lure body so as to engage with the gear.

In the fishing lure of the present invention, water is circulated through the fishing lure so that the water taken in from a mouth at the front end of the lure body is displaced from a drain outlet provided on the lower side of a gill.

### BRIEF DESCRIPTION OF THE DRAWINGS

FIGS. 1A, 1B and 1C are a side view, a bottom view and a front view of a fishing lure relating to the present invention;

FIGS. 2A, 2B and 2C are views explaining the movement of a lower jaw angle adjusting mechanism relating to the present invention; and

FIGS. 3A, 3B and 3C are structural examples of the lower jaw angle adjusting mechanism relating to the present invention.

### DETAILED DESCRIPTION OF THE PREFERRED EMBODIMENTS

Hereinafter, preferable embodiments of a fishing lure according to the present invention will be explained based on the attached drawings.

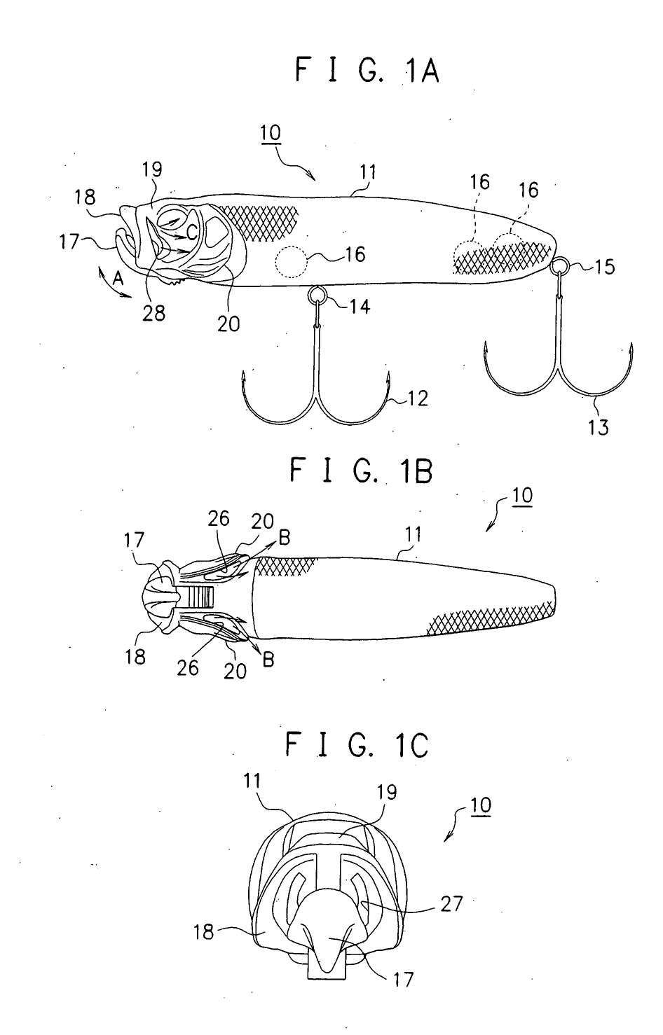

FIGS. 1A, 1B and 1C show an example of a fishing lure 10 in the present embodiment. FIG. 1A shows a side view, FIG. 1B shows a bottom view and FIG. 1C shows a plan view. In the drawings, 11 is a lure body, which is formed so as to have an appearance imitating a small fish made of material such as plastic or the like. In this embodiment, the lure body 11 is integrated by abutting light and left two body halves to each other, which are formed by dividing it along the longitudinal direction (in front and behind) of the lure body 11 each other to have a hollow structure.

As obvious from FIGS. 1A, 1B and 1C, it has a long and narrow shape in front and behind, and is used by basically floating on the water surface or near the water surface. When be used, by pulling a fishing line connected to the tip end upper portion of the lure body 11, it makes the lure 10 perform an ostentacious lure action in the vicinity of the water surface.

In this example, a front hook (fishing hook) 12 and a rear hook 13 are provided at the middle (abdominal region) and at the rear. These front hook 12 and rear hook 13 are installed to be supported by hook hungers 14 and 15 engaged with the lure body 11. Furthermore, a metal balance weight 16 is usually embedded in the inside of the lure body 11 as necessary. There may be one or more weights as the balance weights 16 which is or are fixed at a predetermined place in the lure body 11 or movably attached along the longitudinal direction of the lure body 11.

The lure 10 of the present invention includes a lower jaw 17 on the front end of the lure body 11, which is, in particular, vertically pivotable (arrow A in FIG. 1A). The angle of pivoting is adjustable in the lower jaw 17 as described later. The lower jaw 17 is typically made of plastic that is the same in material as the lure body 11. The color of painting of the lower jaw 17 is preferably the same as that of the lure body 11.

Here, a mouth 18 is provided on the front end of the lure body 11 to be formed so as to open wide towards the front side. When the lower jaw 17 pivots upward, the mouth 18 almost closes. In this state, the head 19 including the periphery assumes substantially a compact tapering shape. The peripheral inside of the mouth 18 is formed in a cave-like shape, and the head 19 is installed consecutively to the upper rear of the mouth 18. It should be noted that the inside of the head 19 is hollow, and gills 20 are formed so as to appropriately protrude to the rear downward right and left from the head 19.

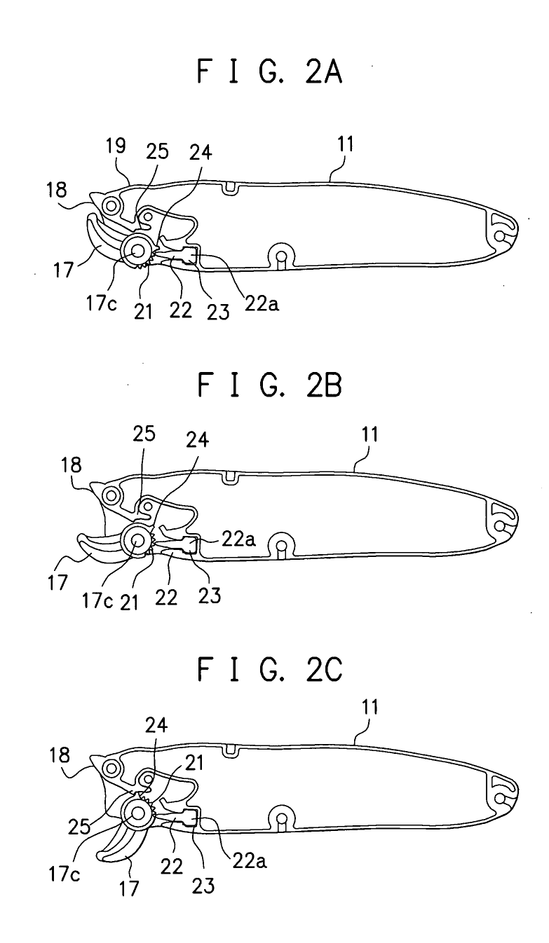

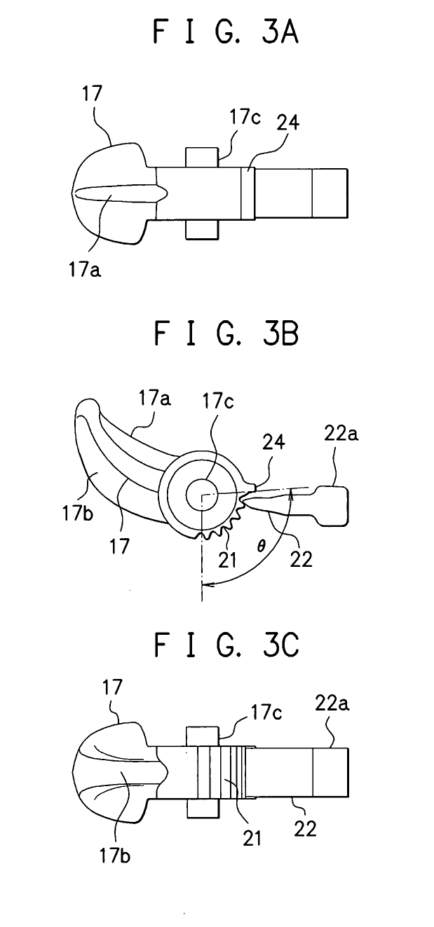

Next, a structural example of the lower jaw 17 including the periphery thereof will be explained in reference to FIGS. 2A, 2B, 2C, 3A, 3B and 3C. In the lure 10 of the present embodiment, the lower jaw 17 is pivotally supported by the lure body 11 at the base, and an angle adjusting mechanism controlling the pivot angle of the lower jaw 17 is included around the pivot.

A specific structure of the lower jaw 17 is generally curvedly formed in a shovel or spoon shape, and includes protrusions 17a and 17b on the central portion vertically protruding along fore-and-aft direction. The base is formed substantially in a cylindrical shape or a drum shape, and pivots 17c are protrusively formed on both right and left sides at the central portion of the base. The pivot 17c fits into a bearing hole (not shown) formed in the lure body 11, and the lower jaw 17 is pivotably supported by this structure via the pivot 17c.

As described above, in the lower jaw 17, the pivot angle is controlled by the angle adjusting mechanism. In the present embodiment, the angle adjusting mechanism includes a gear 21 integrally formed on the (base of) lower jaw 17 around the pivot 17c, and a locking piece 22 held by the lure body 11 so as to engage with the gear 21. The locking piece 22 is typically made of plastic or metal or the like.

The gear 21 is formed at a portion of the base periphery of the lower jaw 17. In this instance, it is provided with a range of about θ=90° on the rear downward of the base. The size of a tooth, a pitch, and so on of the gear 21 are suitably determined as necessary. The locking piece 22 is formed in a wedge shape or a tapered thin spatula shape, and has appropriate flexibility and stiffness. The base 22a of the locking piece 22 is formed substantially in a prism shape, and is fit into and held by a holding unit 23 (refer to FIGS. 2A, 2B and 2C) formed in the lure body 11. The locking piece 22 is practically supported in a cantilever type, and the tip side can be appropriately bent.

A stopper 24 is provided at an end of the gear 21. A protrusion 25 on which the stopper 24 is abuttable is formed on the lure body 11 side so that the stopper 24 abuts on the protrusion 25 when the lower jaw 17 pivots (refer to FIG. 2C). The stopper 24 can abut on the locking piece 22 (the tip side thereof) on the opposite side to the pivoting of the lower jaw 17 as shown in FIG. 3B.

In the above-described case, water can be circulated in a manner that water taken in from the mouth 18 provided at the front end of the lure body 11 can be displaced from the drain outlet 26 provided on the lower side of the gill 20. For instance, as shown in FIGS. 1A, 1B and 1C, an intake opening 27 is provided at a suitable place within the mouth 18, and the intake opening 27 is connected to the drain outlet 26. In addition, a second drain outlet 28 may be provided close to the place just behind the mouth 18. Bubbles and noises are generated by displacing water from these drain outlets 26 and 28, so that a fish-attracting effect can be obtained.

In the fishing lure of the present invention, the cast lure 10 moves around the water surface by pulling the fishing line after landing on the water. At that time, the moving pace of the lure body 1 can be controlled by adjusting the degree of pulling the line or according to the stream of water.

When the lure 10 is forced to move around, a stream of water first hits around the mouth 18, and the pivot angle of the lower jaw 17 is adjustable as described above. The manner of receiving the stream of water by the lure 10 can be modified by changing the pivot angle of the lower jaw 17. For instance, when the lower jaw 17 pivots upward as described in FIG. 2A, the lower jaw 17 covers the mouth 18. Under such a condition, the mouth 18 and around the head 19 form a shape of substantially tapered compact and integrated state. At this time, stream resistance becomes relatively small, and a speedy lure action can be realized.

Whereas, by forcing the lower jaw 17 to pivot downward from the state shown in FIG. 2A, the tip of the lure body 11 including the lower jaw 17 and the mouth 18 opens gradually to be an agape state. When the fishing line is pulled at this state, the vicinity of the lower jaw 17 and the mouth 18 receives a stream of water to produce water spray. It is possible to control the degree of generated water spray by adjusting the pull of the fishing line. Moving around of the lure while generating water spray causes formation of small bubbles or generation of sound of water splashing, which makes it possible to obtain a high fish-attracting effect to target fishes.

When the lower jaw 17 opens appropriately in the state shown in FIG. 2B, and further opens at its maximum as shown in FIG. 2C, it effectively catches water during movement of the lure 10, so that the so-called slideless movement in the water can be realized. Thus, the lure 10 is made easier to move to a target point precisely. As described above, by controlling the pivot angle of the lower jaw 17 with the angle adjusting mechanism, it becomes possible to establish the most suitable lure action characteristics so as to be able to respond swiftly the fishing circumstances. In other words, it becomes possible to realize different types of lures such as a pencil bait, a popper, a splasher, and the like with a single lure 10.

As described above, when the pivot angle of the lower jaw 17 is adjusted by the angle adjusting mechanism, it is possible to set and retain the lower jaw 17 to a desirable angle exactly by engaging the locking piece 22 with the gear 21. Furthermore, when the lower jaw 17 pivots, the locking piece 22 appropriately bends to climb over the teeth of the gear 21. Thereafter, it engages with a requested tooth so as to fix the lower jaw 17. AT the both ends of a pivot stroke, the stopper 24 abuts on the locking piece 22 or the protrusion 25 to control the pivot movement.

Furthermore, the gear 21 and the lower jaw 17 are integrated together, and these members are typically made of the plastic of the same material as that of the lure body 11. Coating of these members in the same color as the color of the lure body 11 avoid the feeling that these are different parts, and has an excellent appearance characteristic. In addition to that, the locking piece 22 is also made of plastic, which creates an inconspicuous outside appearance because of the same reason, and at the same time, contributes to reduce in weight.

As for the engaging structure of the lower jaw 17 with the gear 21 in the angle adjusting mechanism, since it is made of plastic, it has appropriate elasticity and flexibility. For instance, even when the lower jaw 17 collides with an obstacle or the like at the time of casting, it is not easily damaged, and is excellent in impact resistance.

It should be noted that although preferable embodiments of the present invention has been explained, the present invention is not limited to the above-described embodiments, and it is possible to make an appropriate modification thereof as necessary.

For instance, as for the material and others of the lower jaw 17 or the like, it is possible for it to be made of metal or carbon. Furthermore, by making the lower jaw 17 larger, it may easily receive the stream resistance.

According to the present invention, the pivot angle of the lower jaw is controlled by the angle adjusting mechanism, the optimum lure action characteristic can be established, which makes it possible to correspond to fishing circumstances swiftly. In other words, it is possible to realize different types of lures with a single lure.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A fishing lure having a lure body formed to have an appearance imitating a small fish, said fishing lure comprising:
a lower jaw vertically pivotable at the front end of said lure body,
wherein a pivot angle of the lower jaw is made adjustable.

2. The fishing lure according to claim 1, wherein said lower jaw is supported pivotally by said lure body at the base, and comprises an angle adjusting mechanism controlling the pivot angle of said lower jaw around the pivot.

3. The fishing lure according to claim 2, wherein said angle adjusting mechanism comprises:
a gear integrally formed on said lower jaw around said pivot, and
a locking piece held by said lure body to engage with the gear.

4. The fishing lure according to claim 3, wherein said gear includes a stopper at an end of said gear, and the stopper is able to abut on said locking piece and a protrusion formed on said lure body respectively.

5. The fishing lure according to claim 1, wherein water is circulated through said fishing lure in such a manner that the water taken in from a mouth at the front end of said lure body is displaced from a drain outlet provided on the lower side of a gill.

6. The fishing lure according to claim 2, wherein water is circulated through said fishing lure in such a manner that the water taken in from a mouth at the front end of said lure body is displaced from a drain outlet provided on the lower side of a gill.

7. The fishing lure according to claim 3, wherein water is circulated through said fishing lure in such a manner that the water taken in from a mouth at the front end of said lure body is displaced from a drain outlet provided on the lower side of a gill.

8. The fishing lure according to claim 4, wherein water is circulated through said fishing lure in such a manner that the water taken in from a mouth at the front end of said lure body is displaced from a drain outlet provided on the lower side of a gill.
